(19) United States
(12) Patent Application Publication
(10) Pub. No.: US 2010/0281467 A1
(43) Pub. Date: Nov. 4, 2010

(54) METHOD AND APPARATUS FOR AUTOMATIC SOFTWARE TESTING

(75) Inventors: Hector A. Arteaga, Naucalpan (MX); Ryan C. Horton, Camarillo, CA (US); Vaughn Paladin, San Jose, CA (US); Abdiel Alejandro Mancilla Barajas, Saltillo (MX); Javier Salinas Acosta, Rio Bravo (MX)

Correspondence Address: MORRISON & FOERSTER LLP, 755 PAGE MILL RD, PALO ALTO, CA, 94304-1018, US

(73) Assignee: HEXAWARE TECHNOLOGIES, INC., Jamesburg, NJ (US)

(21) Appl. No.: 12/432,572

(22) Filed: Apr. 29, 2009

(51) Int. Cl. G06F 9/44

(52) U.S. Cl. 717/126; 714/E11.029

(57) ABSTRACT

System and method for automated testing of computer software, especially for business process (enterprise) computer software applications. The present system generates scripts for testing software in an automated manner. Business process testing scripts, for instance for functional automated software testing, are thereby converted by an adapter to other types of testing scripts, for instance for testing performance or security or application monitoring.

### FIELD OF THE INVENTION

This invention relates to testing of computer software and more specifically to systems and methods for automated testing of software that executes business processes.

### BACKGROUND

In the field of computers and computer software, business process application software allows for the definition and execution of business processes in a computer system. See commonly owned U.S. Patent Publication US2007/0089091A1, published Apr. 19, 2007, “System and Method for Generating Business Process Test Elements”, inventors Bassam A. LARAB et al. and U.S. Patent Publication US2007/0088668A1, published Apr. 19, 2007, “System and Method for Testing Business Process Configurations”, inventors Bassam A. LARAB et al., both incorporated by reference herein in their entireties.

Examples of business processes include updating customer information, receiving and fulfilling orders, synchronizing customer information stored on multiple computer systems, and generating a price quote. Such computer based business processes are often associated with data descriptions and transformation rules for accessing individual data items, such as a customer name or a unit price and are not limited to businesses. A business process specifies a sequence of activities to be performed in a specified order, and may specify conditional and repeated execution of activities. Business process application software can execute a business process, prompting for or retrieving input data as needed, and produce results or effects, such as output data or execution of database transactions. A business process application configuration includes a set of business processes and associated data, including data descriptions and transformation descriptions, which specify how to execute one or more particular business processes using general purpose business application software such as supplied by SAP or Oracle (formerly Siebel). Configuration information is typically represented as data stored in disk files or in an online repository, depending on the particular business process application software.

The business process software can load the configuration information, including the business process, and subsequently execute the business processes. For example, a shipping company may have a business process application configuration, including a computer system or an SAP software with a shipment received business process, which is to be executed when a shipping container arrives at a transit hub. The shipment received business process updates an inventory database of shipping container locations, invokes another computer system to route the shipping container to its destination. The shipping company may have a second business process application configuration consisting of another computer system running Oracle application software with a confirmed order business process, which is to be executed when an order has been processed. The confirmed order business process, which is invoked by an order processing system, retrieves the customer's email address from the Oracle application software and sends an email notice to the customer describing the order.

It is desirable to test execution of a business process application (application in this context refers to a computer program) configuration for correctness. Testing a software program involves interacting with the program in a test environment and verifying that the program operates correctly, based on the program's behavior in response to input supplied during the interaction. The interaction may be manual testing performed by a human being or automated testing performed by a computer test program. Automated testing is desirable because human effort is not necessary to perform the testing. Hence automated testing is less expensive and more consistent than manual (human) testing once the tests have been developed. However a substantial time and effort may still be involved in creating the tests, which typically are themselves computer programs. Test automation systems which are computer programs have been developed to reduce the time and effort involved in creating automated tests.

Test elements can be created manually by a user (person) interacting with the testing system. To create a new test element for a particular operation, the user first perceives a format of the input data, i.e., the names and types of the input fields of the operation. Then the user may add field setting elements to the new test elements to set values of the operations input fields. The user may also add field getting elements to retrieve output values produced by the operation. The test element can then be used by the testing system to invoke the transaction. For the example of a purchase order operation, a user could create a purchase order test element by first looking at the purchase order operation screen or documentation to determine that the purchase order operations input includes an item, a name, and a quantity. The user would then create an empty complex element and add field setting elements for the item name and quantity fields to the empty complex element.

The purchase order test element could then be included in business process test to invoke the purchase order operation, see the above cited U.S. Patent Publication US2007/0089091A1. That patent application describes generating business process test elements for automated testing of business process application configurations. A business process application executes business processes explained above which are typically automated operations involving users and information systems and are typically specific to a type of business or particular business operation. A business process test is a set of computer instructions for simulating and end user execution of a business process. The test invokes one or more test elements which are building blocks that codify interactions with business processes. Each element includes a description of the input data accepted by an associated transaction or screen (this refers to the graphical user interface display) of the business process. The element can receive input from a user (human being) or simulate a user via an input interface of the software application, and can invoke the associated business process with the input. The element is generated based upon metadata information retrieved from the business process application. The element provides input to and retrieves output from the application for the associated business process. The element refers to fields of the business process transactions (operations) or screens by names associated with the fields. The names may be internal application names, which are independent of a particular language.

The above cited U.S. Patent Publication US2007/008868A1 describes systems and methods for automated testing of business process application configurations. A test library contains test elements which are building blocks that codify all possible interactions with business processes and business process application configurations. The elements interact with the business process application's user interface. A business process test can be defined in a test development environment by adding data input elements to the test to test specific business processes. The flow of execution and a business process test can be defined by adding control elements to the test. The control elements interact with the application's user interface to submit or cancel business process operations.

The business process test can be executed as a test script to perform automated testing. The test can continue to function properly when the application or its user interface changes, because the elements are independent to most details of the user interface. The term “script” here is used in the context of computer programming where a script is, for instance, a program or sequence of instructions interpreted or carried out by another computer program rather than by a computer processor (which is the case with a typical compiled computer program). There are computer languages conceived expressly as script or scripting languages such as JavaScript. In the context of the World Wide Web there are well known scripting languages such as Perl, VBScript and others specifically designed to handle forms, output or other services for a website which is processed on a web server.

Generally script languages are easier and faster to code than more structured and compiled languages such as C and C++. However typically scripts have the disadvantage of taking longer to execute than a compiled program since each instruction is handled by another program first rather than directly by the basic instruction processor. In other words, a scripting language or script language or extension language is a programming language that allows one to code scripts which allow control of a single or several software applications. Scripts are sometimes in the computer field regarded as distinct from other programs which are compiled and which execute independently from any other application.

Typically a script is distinct from the core code of the software application which is usually written in a different language and also the script is accessible to the end user, hence enabling the behavior of the application to be adapted to the needs of the user. Scripts as described above are often, but not always, interpreted from the source code unlike the application, which is traditionally compiled to machine or object code. (The name “script” is taken from the written script of the dramatic performing arts in which dialog is set down to be spoke by human actors.)

Present FIG. 1 is essentially identical to FIG. 1e of above cited U.S. Patent Publication US2007/0088668A1 and shows in a block diagram a business process test environment as also used in accordance with the present invention. The business process test environment 191 includes a business process test development environment 190, a script generator 178, and a test script 193 which is used to test software as disclosed above. The development environment 190 includes a user interface such as a graphical user interface (not shown), which allows a user 195 (a human being) to select elements from a list 196 of predefined elements to create a business process test 141, e.g., by dragging and dropping predefined elements from the list 196.

It is to be understood that this is all in the context of conventional computer technology as explained further hereinafter and all taking place on a computer accessible to user 195 and executing the various software elements shown in FIG. 1.

Present FIG. 2 which is identical to FIG. 1f of the same patent application shows the test script execution environment 192. The predefined elements are complex elements 112 and simple elements 140 provided by a test library 101, also explained in the above cited patent application. The elements invoke application wrapper functions 151 to interact with the application interface logic 111. The business process test includes a list of element calls 172 and each element call includes an actual parameter list (not shown in this figure). An actual parameter in the list may include an input variable. The input variable is provided by either the test development environment 190, e.g., as default values, or by the user 195, typically at the time the business process test 170 is developed by the user 195. A script generator 178 converts the business process test 170 into the test script 193. This is a script of the type described above. This test script 193 can perform the business process test 170 by invoking a business process application as described above. The test script 193 includes computer program code in a computer language of the type described above or of the type for instance of visual basic and can be stored in a file for later use or for use by other testing elements.

The test script 193 is produced by the elements of FIG. 1. The test script execution environment 192 of FIG. 2 may be, for example, a computer operable to execute both a business process application 110 of the type described above and the test script 193. The test script execution environment 192 includes business process application configuration 100, the test script 193 itself for testing the business process application configuration 100, and a test controller 115 for initiating execution of the test script 193. Again all the elements shown in FIG. 2 are computer software modules or elements. The test controller 115 may be, for example, a user or a computer program for starting and stopping the test. This can be a manual or automated aspect. The business process application configuration 100 includes business process application software 110 of the type described above and supplied by SAP or Oracle or others and corresponds to an installation or deployment of the business process application 110. The business process application 110 includes application interface logic 111, which may be, for example, a graphical user interface. The business process application 110 also includes a configuration information set 112, which may include business processes (not shown) and other configuration information specific to a particular user organization or specific to a particular computer installation.

The test script 193 is executed in response to commands from the test controller 115, to perform automated testing of the business process application 110. The test controller 115 is, for example, a human operator or a computer-executable script. When the test script is executed, it performs the business process test 170 of FIG. 1 by invoking the application wrapper functions 151 and global functions 152 of test library 101 to request the application 110 to perform the operations specified by the business process test 170. The rapper functions 151 in turn invoke the application logic interface 111 which initiates the requested operations in the application 110.

The typical initial testing process is referred to as functional testing because it determines if the business process software performs its tasks properly without error. The resulting test script is referred to as a functional test script since it performs this functional testing. A typical suite software that supports this type of activity is provided commercially by Hewlett Packard and includes the Quality Center software which is test management software which interacts with the QuickTest Professional (functional test) and QAlnspect (security test) software.

### SUMMARY

In accordance with the present invention, an improvement has been made in the development of such test scripts. As described above, typically a test script performs only one type of testing. For instance as described above the most basic type of testing is referred to as functional testing. The above process allows development of such test scripts for functional testing. However the present inventors have recognized that other types of software testing are also routinely carried out. In addition to the functional (“verification”) testing there is performance testing (performance referring to speed of execution and capacity of the application to sustain concurrent transactions) and security verification or security testing as well as post production application monitoring. Such security testing ensures that the business application is not vulnerable to attack at the system and application level. Existing testing programs perform each of these, that is the functional testing, performance testing, application monitoring and security testing. However up to now providing scripts for carrying out each of these testing functions is an independent activity and typically carried out by different people in an organization and requires manual development of each of type of test scripts.

The present inventors have recognized that it would be highly desirable to take the original business process test script for functional testing and from that develop other test scripts such as a performance and/or security test script. For instance one example of performance testing software provided by Hewlett Packard is referred to as LoadRunner. The Hewlett Packard test software for security is referred to as QAlnspect. So in accordance with the present invention, after the functional test script is developed, it can be used to generate a performance test script and also a security test script. It also could be used to provide other types of test scripts as needed. In accordance with the invention this is done with minimal human interaction thus substantially increasing the speed and decreasing cost of developing such test scripts.

The present invention therefore is directed in one embodiment to converting the automated business process test script which is generated for functional testing into a performance test script including transaction markers (timers) and comments. Similarly the automated business process test script is converted into a security verification test script. Of course the invention is not limited to test scripts of these particular types. The conversion (adaptation) is performed by a software module referred to here as an adapter. The term adapter has a general meaning in the software field, but here it performs a software conversion process. In one embodiment, a first adapter converts the functional test script into a performance test script and a second adapter converts the functional test script into a security test script.

While certain descriptions here are in the context of Hewlett Packard supplied software that is of course not limiting, but merely illustrative. In one embodiment, a first adapter converts an automated business process test script into for instance a Hewlett Packard LoadRunner performance test script, including transaction markers and comments and a second adapter converts the automated business process test script into a Hewlett Packard QAlnspect security verification test script. Also it is possible by using another adapter to convert the functional test script into an application monitoring test script. In other words a single business process test script can be used to generate test scripts of other types.

Use of the present adapter is relatively simple. After the business process functional test script is initially conventionally developed, that business process test script is executed using the performance adapter. This generates a performance test script. This new performance test script includes what is referred to in this context as server transactions (interactions), that are for instance on a web page use of buttons, pages, or links for each server transaction, and also comments may be added to the script.

A similar process is used to generate the security test script from the business process test script. Note that the original business process test script may be an existing one or one newly created for purposes of functional testing. Of course it is not necessary to begin with the functional test script; that approach is merely illustrative.

### BRIEF DESCRIPTION OF THE FIGURES

FIG. 1 shows a business process test environment in the prior art.

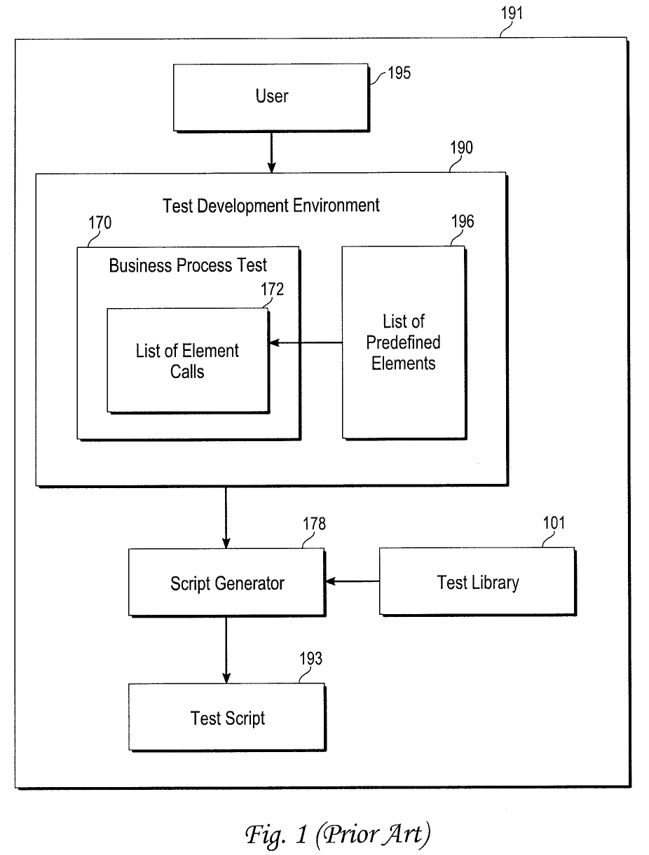

FIG. 2 shows a test script execution environment in the prior art.

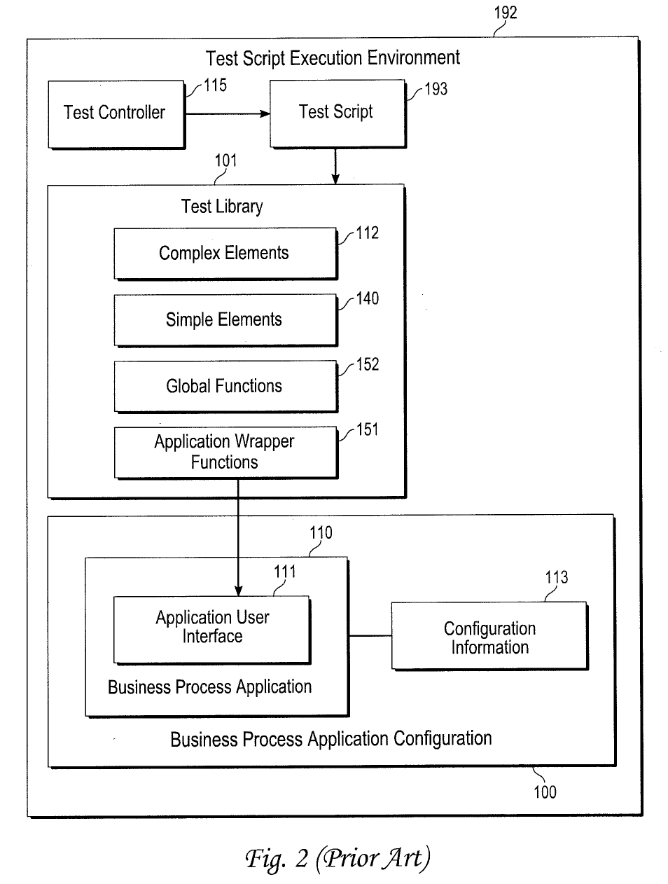

FIG. 3 shows an illustrative computer system that can run processes in accordance with the invention.

FIG. 4 shows in a block diagram both the apparatus and method in accordance with the present invention.

FIGS. 5A, 5B show a user interface for performance script generation in accordance with the present invention.

FIG. 6 shows data flow for the present security adapter in accordance with the invention.

FIGS. 7A, 7B show a user interface for security script generation in accordance with the present invention.

### DETAILED DESCRIPTION

In the context of script creation, the present process includes first conventionally documenting the business process application software. Then one conventionally develops the original business process functional test. This business process functional test is executed against the underlying application, such as a SAP or Oracle software application, supporting the underlying business process. First, one identifies candidates for the performance script testing. One then executes the business process test script (for functional testing) using the performance adapter. One then saves the resulting performance test script and then later uses it for actual “production” purposes, that is monitoring of operation of the software.

While two particular types of software adapters are disclosed here, it is readily understood by those of ordinary skill in the art that this can be extended to other types of adapters for adapting a first script intended for a first type of testing to a second script intended for a second type of testing.

The present type of testing environment is typically in the context of an application server running the underlying software application and with the test script and associated test program being executed by a client, which is a separate set of software executed on a computer connected to the server by means of, for instance, a network such as Ethernet or the Internet. But this is not limiting here. Hence the present configuration of computer hardware and the network is not limiting in terms of development of test software.

In one commercial environment, the business process test script is generated by the BPT “accelerator” provided by FocusFrame. This accelerator is commercially available. The accelerator is used to develop the original test script. However even in a particular environment, if one does not choose to use the FocusFrame accelerator or equivalent, the present adapters can still be used. In that case the development of the test scripts requires manual input to add code statements that allow the transaction monitoring and comments to be included in the resulting script. The user then identifies a particular business process test script that he or she wishes to convert into either a performance or security test script and begins execution using one of the adapters. The following parameterization and correlation activities will continue until the script is approved for use, and these two steps occur whether or not the accelerators are used. Further, once the performance or monitoring scripts are created, the user must parameterize and correlate as necessary as is conventional.

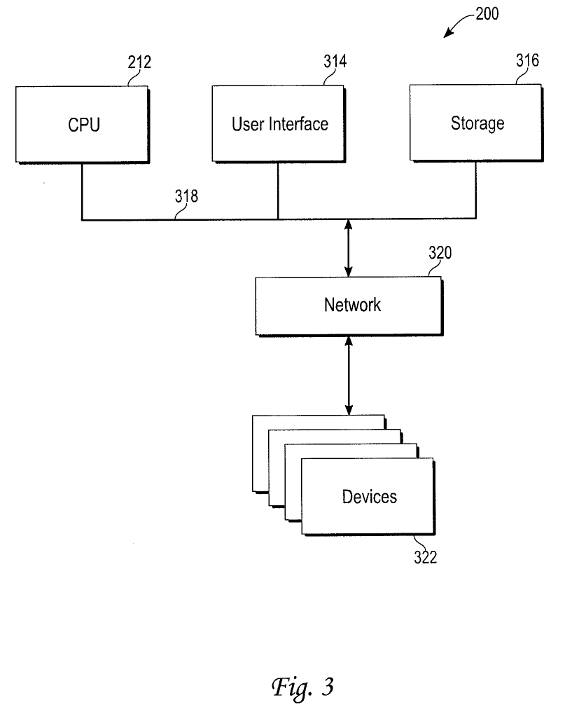

FIG. 3 is a block diagram of an illustrative conventional computer system 200 that can be used in accordance with the invention. For instance this is the client platform or user computer or personal computer used by the person who is developing test scripts or executing such test scripts. The computer system 200 typically includes one or more central processing units (CPU) 212 coupled via a system bus 318 to a user interface 314 including for instance computer screen, keyboard, mouse, etc., with bus 318 also being coupled to conventional storage (computer memory) 316. The computer system 200 is coupled via a network 320 such as an Ethernet network or the Internet to other computing devices 322, which would include for instance servers. In this context computer system 200 is a client with server(s) 322 being the hosts. Typically the servers 322 or other computing devices store and execute the underlying applications. Data structures and software (computer code) can be stored in storage 316 which is also referred to as computer memory. Computer program instructions which are the elements of the code can cause the CPU 212 to generate the test elements shown herein.

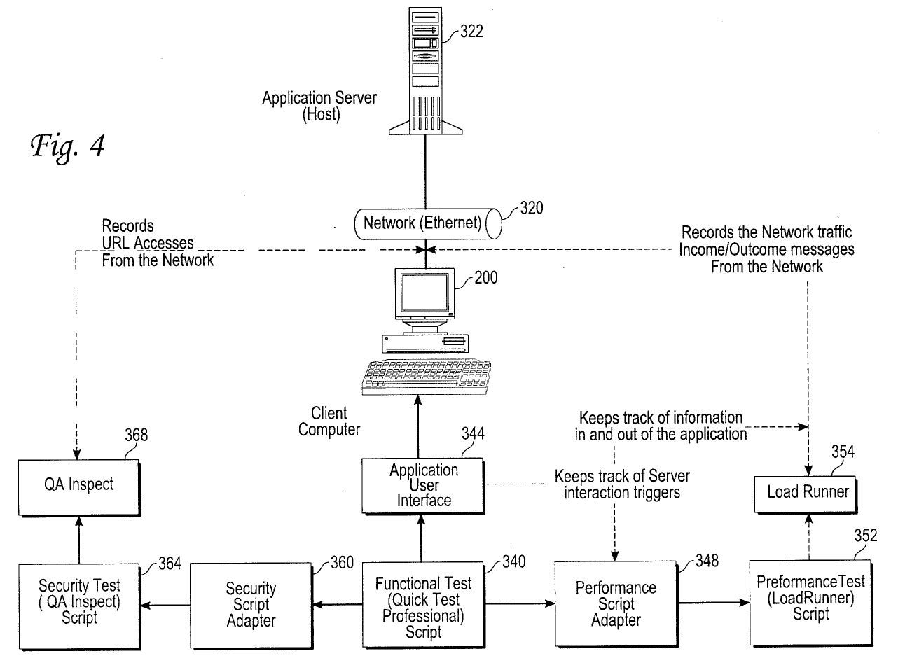

FIG. 4 shows elements of FIG. 3 combined with others in accordance with the present invention. Here server 322 is identified as the host. The term “server” here refers in computer terminology both to the server platform which is the physical computer and the associated server software. The same is true of the client computer platform and software 200.

Also shown in FIG. 4 is application user interface 340. It is to be understood that typically the actual business process application (not shown) is resident on server(s) 322 and only its user interface 340 is executed on the client computer 200. Also software modules stored in the memory of computer 200 are the functional test script 344 and the associated performance test script 352 of the type disclosed above. As shown in this case these are respectively scripts for QuickTest Professional and LoadRunner software commercially available from Hewlett Packard. However these are merely representative of two different types of tests. Of course while these particular tests are commercially available test software, the test software need not be commercially available as long as the two tests are generally compatible.

Also provided in this case is the adapter software 348 described in further detail below that actually performs conversion of the functional test script 344 to the performance test script 352. As shown the application user interface 340 keeps track of the server interaction transactions. The adapter 348 tracks the information (data) as it moves in and out of the application 340 to generate the test script 352. Later, the performance test software 354 when executed conventionally under control of performance test script 352 records the network traffic (incoming and outgoing messages). The performance test script 352 is what is referred to as a VuGen script. (VuGen—Virtual User Generator—is Hewlett Packard software allowing a user to record and/or script a software test and is an application that is part of LoadRunner that creates performance testing scripts.) VuGen here is relevant only to generation of the performance testing scripts. Also shown is the security adapter 360 which adapts script 344 to generate security test script 364 which runs the QAlnspect application 368, also resident on client computer 200.

The following is an example of annotated pseudo code showing the internal structure of the performance adapter 348:

```
These are the actions that are currently being monitored,
but are not limited to:
Click
Enter
Screen Change
For each action detected
  Locate VUGen window
  Get Handle ID HWID
  Send message to
    Start transaction
    End transaction
  Enter Transaction name
  Send message to press ok
wait for next action
Enter Comment pseudo code
  Locate VUGen window
  Get Handle ID HWID
  Send message to
    Insert Comment
  Enter Comment text
  Send message to press ok
Change Action context
  Locate VUGen window
  Get Handle ID HWID
  Send message to
    Change Action context
  Select Action context name
```

Normally the performance adapter 348 automatically replicates comments found in the functional testing script in the generated performance testing script. But the user can optionally add other transactions and/or comments. The handle here conventionally is a Microsoft Windows term. VUGen supports at least three types of user actions as referred to in the above pseudo code used for respectively logging into the application, using the application, and leaving the application. These actions are identifiers used within VUGen. When a new action is created, a new script (.C) file is created. This is used to facilitate looping (iterations) within the script. The references in the pseudo code to action context refer to changing between these three types of actions.

It is to be appreciated this pseudo code is not executable computer code, but is intended to illustrate the logic of actual computer code, and given this pseudo code one of ordinary skill in the art could readily code the actual adapter software. The adapter is coded in the VBScript language or C#.NET language for instance which both include scripting as part of the Hewlett Packard QuickTest Professional software, but any other type of scripting language or other equivalent computer language would be suitable. In this case a “transaction” is actually a timer (and not a business operation) in the software sense. In this case these scripts are in the context of the commercially available HP LoadRunner software. The Windows message queue is used to interact with the Hewlett Packard VuGen and to add transactions, transaction names, comments to the script 352. Further detail of this is illustrated below. Windows message queue is a message queuing technology commercially provided by Microsoft which enables applications running at different times to communicate across heterogeneous networks and systems that may be temporarily offline. This provides message delivery, efficient routing security and priority based messaging. It is suitable for asynchronous and synchronous messaging scenarios.

In this case a “transaction” is a timer which identifies the time between a client 200 makes a request to the server 322 and the time it takes the server to respond to the client request. Transactions conventionally have names generated from the information available that characterizes the associated data or the transaction type. (These names of course are for human use.) Conventionally transactions are used to identify when an action is being taken. For example a transaction will define in which part of the script is being dealt with, the screen name and the actions taking place. Each transaction must have a name in VUGen. The user may enter the transaction name, but names also may be automatically generated. The insertion of the transaction in the script is also referred to as the recording phase of creating a script. In this recording phase, the actual script is first recorded with transactions, that is the transactions are inserted. Each transaction is a timer used to record the time a specific event takes to execute. The present performance adapter automatically inserts transactions for each server interaction as seen in this pseudo code. Additional transactions can optionally be inserted into the functional test script by the user, enabling the adapter to insert them into the resulting performance script.

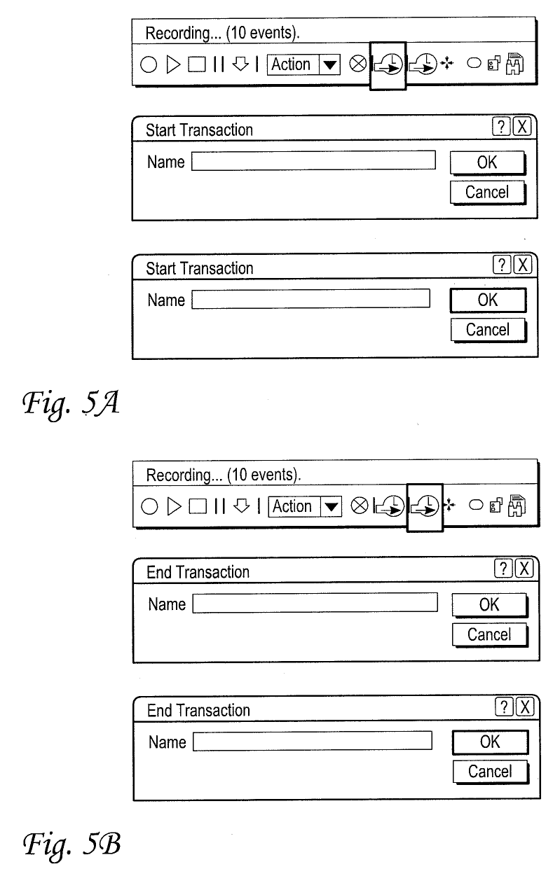

FIGS. 5A, 5B show an illustrative user interface of the adapter 348 as a set of VUGen windows. This is what the user may see in terms of screen displays when he invokes the adapter 348. The screenshots and other aspects of FIGS. 5A, 5B are the result of execution of the code corresponding to the above pseudo code. These screen shots of VuGen are for illustrative purposes, but the user will generally not interact with VuGen when using the adapter. These windows may be visible to the user, but not always visible due to other windows being present, and typically will not actually be interacted with during the script creation phase while using the adapter.

It is assumed as disclosed above that the LoadRunner (performance test software 354) and message queue listener (which is a more generic name for the Windows message queue conventionally installed in a computer having the Windows operating system) are already installed on the client computer 200 along with adapter 348. A standard performance recording would proceed as follows per the pseudo code. First the adapter user starts VuGen. He then starts a new “recording” on VuGen (or its equivalent). Then as shown in the first box at the top of FIG. 5A, the adapter inserts the needed transaction as shown in the first box in FIG. 5A, which begins the transaction in the VuGen script. It then enters the transaction “name” by entering the name for the transaction in the second box in FIG. 5A. This process is repeated throughout the creation of the performance test script.

The performance adapter 348 takes care of all these actions automatically without human interaction. The adapter is a program (script) that finds the correct window handle (VuGen) and sends the appropriate messages to the Windows Message Queue with the appropriate wPARAM and 1Param to continue the same course of action. Then as shown in the top of FIG. 5B the adapter enters the name of the transaction which it is currently interested in to end that transaction. To summarize this process, the result is a dynamically linked library that works with just two functions, start transaction and end transaction. The performance adapter 348 operates by receiving a call for a software function. The adapter searches for the VUGen (or equivalent) window and identifies the window handle. The adapter then uses the identified handle and sends a message to the windows queue listener using the handle and the correct parameters. The adapter then inserts the transaction name into the script.

The above pseudo code is for the performance adapter 348. The security adapter 360 functions somewhat similarly, but converts a business test performance script to a security test script, for e.g. QAlnspect. Security testing is usually done in one of two ways. The first tells the security testing application 368 which URL (Universal Resource Locator) to crawl through and audit. The second examines a business process and crawls and audits it for each URL used in the business process. The present security adapter 360 uses the second approach. This security adapter 360 allows the security testing script 364 to be generated direct from the business process test script 344. Note that in for instance the above described Hewlett Packard test software that the scripting language and format for security test scripts differ from that of the business process (functional) test script and the present security adapter 360 takes that into account. The same is true for the present application monitoring adapter.

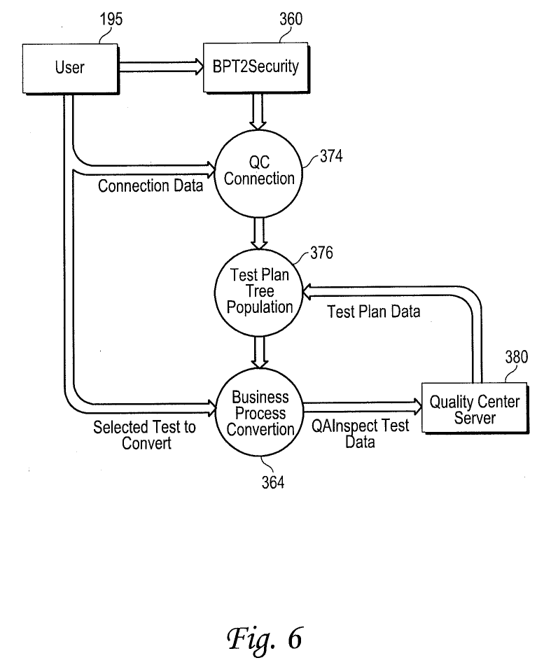

FIG. 6 shows the environment and data flow for operation of the security adapter 360 interacting with user 195 where elements 370 are resident on the user client computer 200, not shown, and interact with the Quality Center server 380. A connection to the Quality Center (QC) is made by the security adapter 360 to convey the needed connection data. A conventional test plan tree with its “population” 376 is provided as conventional in security testing. This test plan tree interacts with the conventional Quality Center server 380 to access the test plan data. The user then determines which test to convert (see below) and converts the business process test script into the security test script 364. This script 364 in turn, when run, executes the QAlnspect software (not shown here) and provides the resulting QAlnspect test data back to the Quality Center server 380

The following shows annotated pseudo code for the security adapter 360, where “QC” stands for the Hewlett Packard Quality Center software and this operates in the context of the data flow diagram of FIG. 6. Hence given this disclosure, coding the security adapter (or any other type of similar adapter such as the application monitoring adapter) would be routine to one of ordinary skill in the art.

```
Initialize Pseudo Code
  While QC Connection is not connected
    If QC Connection data is stored then
      Connect to QC Server using stored data
      Connect to QC Domain and Project using stored data
    Else
      Show Connection Dialog for user to input connection data
    End if
  End While
  Populate test plan tree using tests from QC Test Plan
Convert Business Process Pseudo Code
  Set WebMacroPath to Path chosen by the user to store webmacro
  If there is no selected test in test Plan tree then
    Display user message “Please select a test to Convert”
    Exit Procedure
  End if
  If selected test ID from test plan tree is numeric then
    Set TestName to Selected Test name in test Plan tree
    Launch QuickTest Application
    Set QuickTest Application Visible property to true
    Set WebMacroName to concatenation of WebMacroPath, TestName
    and “.webmacro”
    Create new Web Macro file as WebMacroName
    Run web macro file (Web Macro Recorder is launched)
    Locate and Activate Web Macro Recorder window
    Send message to Record
    Send message to Launch Browser
    Call RunScript with selected test ID from test plan tree
    Close QuickTest Application
    Locate and Activate Web Macro Recorder window
    Send message to Save Web Macro
    Send message to Exit Web Macro Recorder
    Call UploadWebMacro with WebMacroName, TestName
    Display user message “Test has been converted”
  End if
RunScript Pseudo Code
  Paremeters: TestID
  If QC Connection is connected then
    Create new test set as “BPTConverter” in test lab
    Set test set status to “Open”
    Add Test with ID equal to TestID to new test set
    Start test set execution scheduler
    Set RunAllLocally property to “True”
    Run test set
    While execution status finished property is False
      Refresh execution status info
    End while
    Remove test set “BPTConverter” from test lab
  End if
Upload WebMacro Pseudo Code
  Parameters: WebMacroPath, TestName
  If folder “Subject\QAInspect” does not exist in test plan then
    Create folder “Subject\QAInspect” in test plan
  End if
  Create new test as TestName and “QAINSPECT-TEST” in folder
  “Subject\QAInspect”
  Set QAInspectTestID to new test ID
  If folder “Root\QAInspect’ does not exist in test lab then
    Create folder “Root\QAInspect” in test lab
  End if
  Create new test set as TestName in folder “Root\QAInspect”
  Set test set status to “Open”
Add Test with ID equal to QAInspectTestID to new test set
Set QA Inspect test field “TC_USER_01” to 0
Set QA Inspect test field “TC_USER_02” to 0
Set QA inspect test field “TC_USER_03” to 1
Add Web Macro File (WebMacroPath) as attachment to QA Inspect test
Add Test Config Text File as attachment to QA Inspect test
Add Test Scan Settings XML File as attachment to QA Inspect test
Add Test Web Form File as attachment to QA Inspect test
```

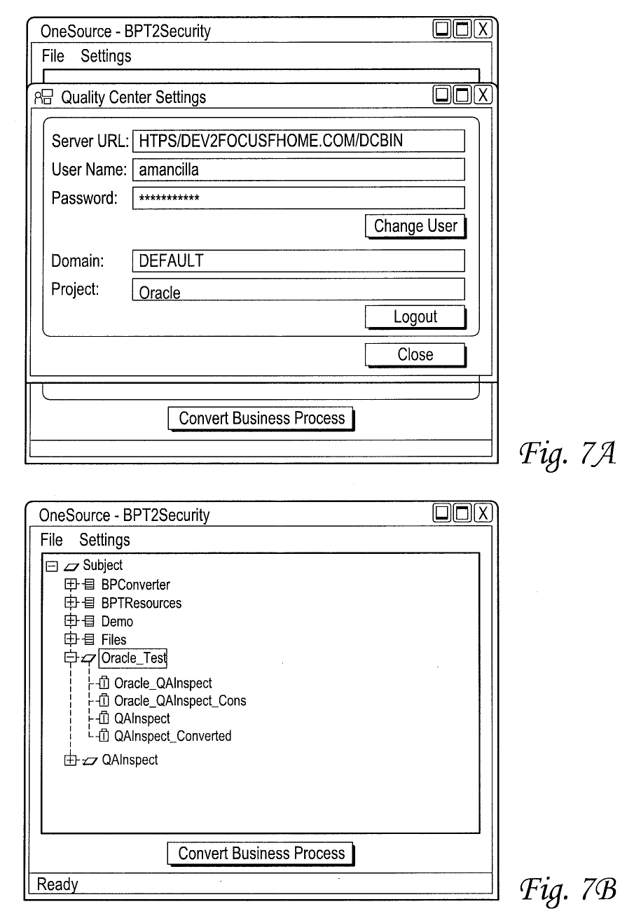

FIGS. 7A, 7B show respective screen shots (windows) of the user interface for this process for the security adapter. FIG. 7A shows the QC (Quality Center) settings. FIG. 7B shows selection of a particular test, in this case QAlnspect.

This disclosure is intended to be illustrative and not limiting. Further modifications will be apparent to those skilled in the art in light of this disclosure and are intended to fall within the scope of the appended claims. Further the above description is exemplary only and will be apparent to those of ordinary skill in the art that numerous modifications and variations are possible. For example, various exemplary methods and systems described herein may be used alone or in combination with various other computer and computer peripherals systems and methods. Particular examples have been discussed and how these examples are thought to address certain disadvantageous and related art. This discussion is not meant, however, to restrict the various examples to methods and/or systems that actually address or solve the disadvantageous.

1. A method of testing a computer software application resident on a server, comprising the acts of:
providing a first script for a first type of test of the application, the first script being stored in computer readable memory in a computer device coupled to the server by a network;
providing an adapter stored in the computer readable memory in the computing device;
executing the adapter on a processor in the computing device coupled to the computer readable memory to generate, from the first script, a second script for a second type of test of the application;
storing the second script in the computer readable memory; and
executing the second script on the processor, thereby to test the application with the second type of test.

2. The method of claim 1, wherein the first type of test is a functional test, and the second type of test is a performance or security test or application monitoring.

3. The method of claim 1, wherein the functional test is QuickTest Professional, and the second type is respectively LoadRunner or QAlnspect.

4. The method of claim 1, wherein the first script is a business process test script.

5. The method of claim 1, wherein the adapter inserts a plurality of transactions in the second script, each transaction being a timer associated with an interaction with the application.

6. The method of claim 1, wherein the adapter inserts comments in the second script.

7. The method of claim 1, wherein the adapter provides a graphical user interface displayed by the processor to a user of the computing device, the graphical user interface providing access to transactions with the server.

8. The method of claim 7, wherein the adapter uses a message queue to insert the transactions.

9. The method of claim 1, wherein the second script is coded in a scripting language.

10. The method of claim 1, wherein the adapter locates each Universal Resource Locator in the first script and audits it in the second script.

11. The method of claim 1, further comprising providing a second adapter stored in the computer readable memory.

12. A computer program product storing computer code for carrying out the method of claim 1.

13. A computing device programmed to carry out the method of claim 1.

14. A computing device comprising:
a port adapted to couple the computing device to a server via a network thereby to access a computer software application resident on the server;
a computer readable memory storing a first script for a first type of test of the application;
an adapter stored in the computer readable memory; and
a processor coupled to the port and to the computer readable memory, wherein the adapter when executed by the processor generates from the first script a second script for a second type of test of the application, and stores the second script in the computer readable memory.

15. The apparatus of claim 14, wherein the first type of test is a functional test, and the second type of test is a performance or security test or application monitoring.

16. The apparatus of claim 14, wherein the functional test is QuickTest Professional and the second type of test is respectively LoadRunner or QAlnspect.

17. The apparatus of claim 14, wherein the first script is a business process test script.

18. The method of claim 14, wherein the adapter inserts a plurality of transactions in the second script, each transaction being associated with an interaction with the application.

19. The method of claim 14, wherein the adapter inserts comments in the second script.

20. The apparatus of claim 14, wherein the adapter provides a graphical user interface displayed by the processor to a user of the computing device, the graphical user interface providing access to transactions with the server.

21. The apparatus of claim 20, wherein the adapter uses a message queue to create the transactions.

22. The apparatus of claim 14, wherein the second script is coded in a scripting language.

23. The apparatus of claim 14, wherein the adapter locates each Universal Resource Locator in the first script and audits it in the second script.

24. The apparatus of claim 14, further comprising a second adapter stored in the computer readable memory.
